(19) United States
(12) Patent Application Publication
(10) Pub. No.: US 2003/0057778 A1
(43) Pub. Date: Mar. 27, 2003

(54) Multiple DC control for single power supply

(76) Inventor: George Ai, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/960,992

(22) Filed: Sep. 25, 2001

(51) Int. Cl. H02J 9/00

(52) U.S. Cl. 307/64

(57) ABSTRACT

A multiple DC control for single power supply, including a power supply unit, a plurality of DC output units and a plurality of control units, and a detection unit. Each control unit is connected between the power supply unit and a corresponding one of the DC output units. Each control unit respectively consists of a protection circuit, a DC ON/OFF control circuit and a DC power control circuit. Thereby, in case of short circuit, poor connection, over-current or other irregularity in any one of the DC output units, the respective control unit in connection will switch off power supply to the DC output unit, without influencing normal operation of other DC output units.

### BACKGROUND OF THE INVENTION

The present invention relates to a multiple DC control for single power supply, more particularly to a device wherein the normal operation of the other output units will not be influenced when one of the DC output units has an irregularity.

As shown in FIG. 1, a conventional multiple DC control for a power supply unit comprises multiple sets of DC output units 60 and a set of current comparator 80 with a current detector R connecting the DC output unit 60 and a power supply unit 50. Whereby, when an over-current flows to any one set of DC output unit 60, it is detected and the circuit is opened immediately to protect the power supply unit 50 from damage.

However, an over-current in either one of the DC output units will affect the normal operation of the other DC output units.

Additionally, there is a multiple DC control device with a single power supply that is applied to the Hub of networks, as shown in FIG. 2, which comprises a power supply unit 50′ and multiple sets of DC output units 60′. Wherein, the power supply unit 50′ generates a DC ON/OFF signal and a set of DC output voltages, which are delivered to each DC output unit 60′ such that each DC output unit 60′ can supply power to the connected equipment. The aforementioned DC output voltages include energy-saving mode voltage (+5 VSB) and DC voltages. The DC voltages comprise +3.3V, +5V, +12V, −12V, −5V and GND;

In the aforementioned circuit design, however, if any one set of the DC output units 60 or 60′ is short-circuited, in poor connection or subjects to an over-current, it will affect the normal operation of the other DC output units.

### SUMMARY OF THE INVENTION

Therefore, the inventor has come up with the present invention whereby the operation of the other DC output units will not be affected when one of the DC output units has irregularity.

The primary objective of the invention is to provide a multiple DC control for a single power supply, wherein a control unit is connected between a power supply unit and multiple sets of DC output units respectively, each control unit including a protection circuit, a DC ON/OFF control circuit and a DC power control circuit. Whereby, in case of short circuit, poor connection or over-current in any one DC output unit, the control unit will switch off power supply to the DC output unit, without affecting the operation of the other DC output units.

### BRIEF DESCRIPTION OF DRAWINGS

FIG. 1 is the structure of the conventional multiple DC control device with a power supply unit.

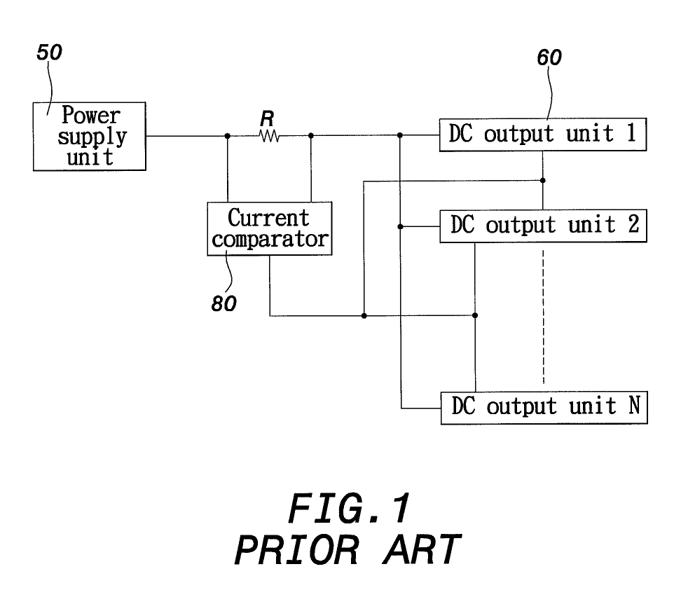

FIG. 2 is the structure of the conventional multiple DC control device with a single power supply applied to the Hub of networks.

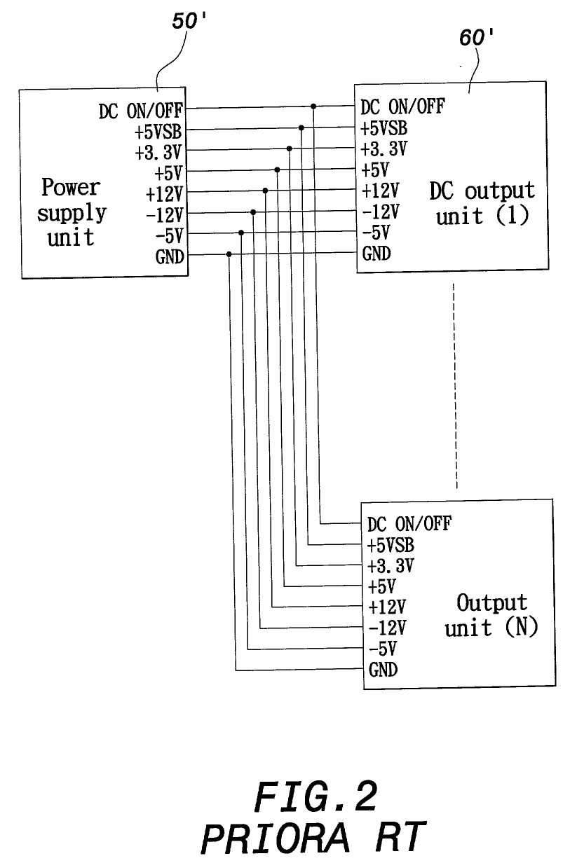

FIG. 3 is the structure of the present invention.

### DETAILED DESCRIPTION OF PREFERRED EMBODIMENTS

For better understanding of the characteristics and techniques of the present invention, please refer to the following detailed description and accompanying drawings, which shall be used for reference and description only and shall not be based to restrict the present invention.

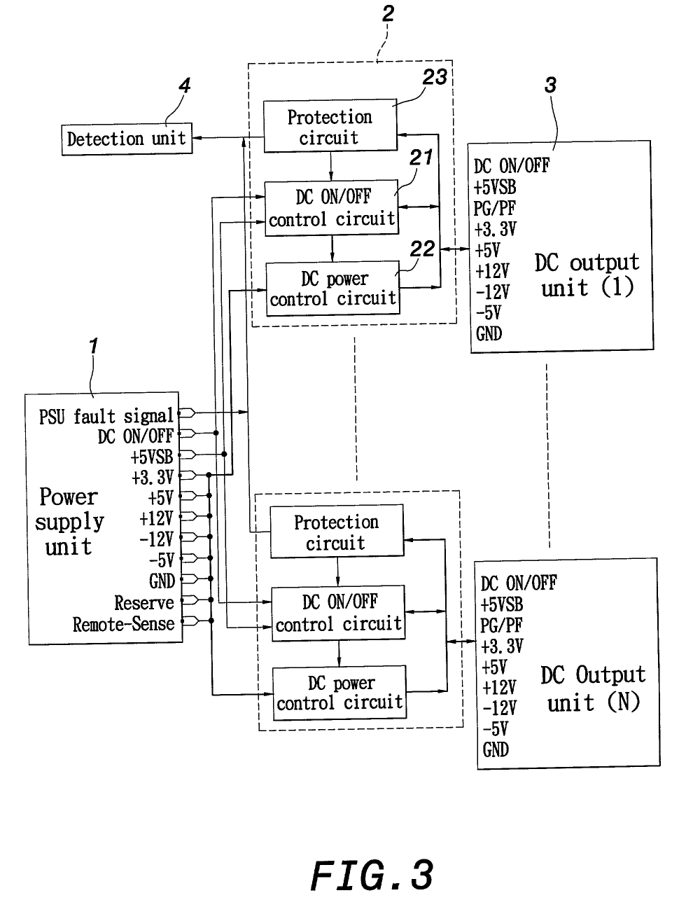

Please refer to FIG. 3, it is a multiple DC control device with a single power supply including a power supply unit 1, multiple sets of control units 2, multiple sets of DC output units 3 and a detection unit 4.

The power supply unit 1 has a power supply unit (PSU) fault signal terminal, a DC ON/OFF terminal, an energy saving mode (+5V SB) terminal, a set of DC power output terminals, a reserve terminal and a remote-sense terminal. The voltages of the DC power output terminals include +3.3V, +5V, +12V, −12V, −5V and GND.

Each control unit 2 is connected between the power supply unit 1 and a corresponding DC output unit 3. The control unit 2 consists of a DC ON/OFF control circuit 21, a DC power control circuit 22 and a protection circuit 23, wherein:

the DC ON/OFF control circuit 21 is connected between the DC ON/OFF terminal of the power supply unit 1, the energy-saving mode terminal (+5 VSB) and a corresponding DC output unit 3;

the DC ON/OFF control circuit 21 is activated when the DC output unit 3 transmits a control signal to the power supply unit 1 and then delivers DC ON/OFF signals and energy-saving mode voltage (+5V SB) to all DC output units 3.

The DC power control circuit 22 is connected between one of the DC power outputs of the power supply unit 1, the DC ON/OFF control circuit 21 and the corresponding DC output unit 3;

upon receipt of a control signal of switch-on transmitted from the DC ON/OFF control circuit 21, the DC power control circuit 22 converts the power good (PG) signal to be high potential, and delivers a power good/power failure (PG/PF) signal and converted DC voltage to the corresponding DC output unit 3;

conversely, when the DC power control circuit 22 receives a control signal of switch-off, the DC ON/OFF control circuit 21 converts a Power Failure (PF) signal to be high potential and stops to supply power to the DC output unit 3.

The protection circuit 23 is connected between the PSU fault signal terminal of the power supply unit 1, the DC ON/OFF control circuit 21 and the corresponding DC output unit 3;

The protection circuit 23 serves to detect short-circuit, over-current, or other irregularity, and transmits control signals to the DC ON/OFF control circuit 1 for switching off the DC ON/OFF control circuit 21 and causing that the power supply unit 1 can't supply power through the DC power control circuit 22 to the DC output unit 3.

The detection unit 4 is connected between the PSU fault signal terminal of the power supply unit 1 and an output of the protection circuit 23;

The detection unit 4 serves to receive the PSU fault signal to determine whether the power supply is invalid and delivers an alarm to the user.

When there is a short circuit, an over-current or other irregularity in one of the DC output units 3, the protection circuit 23 of the control unit 2 in connection with the irregular DC output unit 3 will send a control signal to the DC ON/OFF control circuit 21 to switch off the DC ON/OFF control circuit 21. Then, the power good signal of the DC power control circuit 22 is low potential such that the power supply unit 1 can't deliver the DC power output to the DC output unit 3.

With the aforementioned design, in case one of the DC output units has a short circuit, over-current or other irregularity, the control unit in connection with the irregular DC output unit will stop to supply power to the DC output unit, without influencing the operation of the other DC output units. Therefore, since the present invention has satisfied the requirements of patentability, this application is filed in accordance with the patent law duly. Your favorable consideration will be appreciated.

It should be understood that, the above description of the preferred embodiment shall not be based to restrict the characteristics of the present invention, and all equivalent modifications or variations made without departing from the above description shall be included in the spirit and intent of the subject claim.

What is claimed is:

1. A multiple DC control for a single power supply, comprising a plurality of control units, a power supply unit (PSU) and a plurality of DC output units, wherein each of the plurality of control units is connected with the power supply unit and a corresponding one of the DC output units, and the power supply unit has a PSU fault signal terminal, an energy-saving mode terminal, a DC ON/OFF terminal and a plurality of DC power outputs, and each of the control units comprising:
a DC ON/OFF control circuit, connected between the DC ON/OFF power terminal of the power supply unit, the energy-saving mode terminal and the corresponding DC output unit, the DC ON/OFF control circuit being activated when the corresponding DC output unit transmits a control signal to the power supply unit, and delivering a DC ON/OFF signal and energy-saving voltage to the DC output units respectively;
a DC power control circuit, connected between one of the DC power outputs of the power supply unit, an output of the DC ON/OFF control circuit and the corresponding DC output unit, after the DC power control circuit receives a control signal transmitted from the DC ON/OFF control circuit, the DC power control circuit idles for a while and then delivers a Power Good/Power Failure (PG/PF) signal and a converted DC voltage output to the corresponding DC output unit; and
a protection circuit, connected between the PSU fault signal terminal of the power supply unit, the DC ON/OFF control circuit and the corresponding DC output unit, the protection circuit serving to detect whether there is irregularity in the corresponding DC output unit and transmit a control signal to the DC ON/OFF control circuit for switching off the DC ON/OFF control circuit and causing a failure of DC power to flow from the power supply unit through the DC power control circuit to the corresponding DC output unit;
thereby, in case of irregularity in one of the DC output units, a corresponding one of the control units in connection will switch off power supply to the irregular DC output unit, without influencing normal operation of other DC output units.

2. The multiple DC control for single power supply as claimed in claim 1, wherein the protection circuit of each control unit is in connection with a detection unit, so the user will be able to know any irregularity of the DC output units.

3. The multiple DC control for single power supply as claimed in claim 1, wherein the DC power outputs of the power supply unit comprise +3.3V, +5V, +12V, −12V −5V and GND.
